(19) United States
(12) Patent Application Publication
(10) Pub. No.: US 2002/0107951 A1
(43) Pub. Date: Aug. 8, 2002

(54) Report group management

(76) Inventors: William Teague, Vienna, VA (US); Michael Perry, Bethesda, MD (US)

Correspondence Address: BRIAN J. COLANDREO, Fish & Richardson P.C., 225 Franklin Street, Boston, MA, 02110-2804, US

(21) Appl. No.: 09/949,437

(22) Filed: Sep. 7, 2001

Related U.S. Application Data
(60) Provisional application No. 60/231,677, filed on Sep. 11, 2000.

(51) Int. Cl. G06F 15/173

(52) U.S. Cl. 709/223

(57) ABSTRACT

A report group management process resides on a server and groups a plurality of reports for retrieval over a distributed computing network by an application program residing on a remote desktop computer. A report group definition process defines a user-defined report group and an individual report selection process selects, from a plurality of available individual reports, at least a first report to be included in the user-defined report group.

### RELATED APPLICATIONS

This application claims the priority of U.S. Provisional Patent Application No. 60/231,677, entitled “Folio Generator”, and filed on Sep. 11, 2000.

This application herein incorporates by reference U.S. patent application Ser. No. 09/191,655, entitled “Report Generation Architecture for Remotely Generated Data”, and filed on Nov. 13, 1998.

This application herein incorporates by reference U.S. patent application Ser. No. 09/821,599, entitled “A Report Scheduler”, and filed on Mar. 29, 2001.

### TECHNICAL FIELD

This invention relates to the grouping and generation of reports, and more particularly to automated grouping and generation of reports over a distributed computing network.

### BACKGROUND

The Internet, and in particular the World Wide Web, allows for the rapid dissemination of information to subscribers of various services. This information is typically available in various formats, including reports, wherein the subscriber instructs the service to generate specific reports in accordance with their needs and personal tastes. Some service providers allow the subscriber to download these reports from a remote computer to a local computer via some form of distributed computing network, typically the Internet.

In the world of investments and stock portfolio management, subscribers tend to have the same report(s) repeatedly generated at various points in time so that the price of their entire stock portfolio, a portion of their stock portfolio, or a specific stock in the portfolio can be monitored.

Accordingly, subscribers must repeatedly request the same group of reports every time they are desired. This, in turn, requires a high level of interaction between the service provider and the subscriber.

### SUMMARY

According to an aspect of this invention, a report group management process resides on a server and groups a plurality of reports for retrieval via a distributed computing network by a desktop application program residing on a remote desktop computer. A report group definition process defines a user-defined report group and an individual report selection process selects, from a plurality of available individual reports, at least a first report to be included in the user-defined report group.

One or more of the following features may also be included. The report group management process further includes a report group selection process for selecting, from a plurality of predefined report groups, a predefined report group to be included in the user-defined report group. The predefined report group includes at least a first report to be included in the user-defined report group. The predefined report group is a user-defined report group. The predefined report group is a process-defined report group.

The report group management process further includes a predefined report group deletion process for deleting one or more predefined report groups included in the user-defined report group. The report group management process further includes an individual report deletion process for deleting one or more reports included in the user-defined report group. The report group management process further includes a report group deletion process for deleting the user-defined report group.

The report group management process further includes a manual report generation process for generating at least a portion of the reports included in the user-defined report group in response to an action taken by the user.

The report group management process further includes an automated report generation process for generating at least a portion of the reports included in the user-defined report group at a user-defined specific time. The report group management process further includes a report transmission process, responsive to the automated report generation process generating at least a portion of the reports included in the user-defined report group, for transmitting the reports to the user via an electronic mail delivery mechanism. The report group management process further includes a master delay process that delays the generation of at least a portion of the reports included in the user-defined report group until after a process-defined specific time to minimize server loading.

The report group management process further includes a user interface process for allowing the user to manage the user-defined report group.

According to a further aspect of this invention, a method for creating and managing a report group includes defining a user-defined report group and selecting, from a plurality of available individual reports, at least a first report to be included in the user-defined report group.

One or more of the following features may also be included. The method for creating and managing a report group further includes selecting, from a plurality of predefined report groups, a predefined report group to be included in the user-defined report group. The predefined report group includes at least a first report to be included in the user-defined report group. The method for creating and managing a report group further includes deleting one or more predefined report groups included in the user-defined report group. The method for creating and managing a report group further includes deleting one or more reports included in the user-defined report group. The method for creating and managing a report group further includes deleting the user-defined report group. The method for creating and managing a report group further includes generating at least a portion of the reports included in the user-defined report group in response to an action taken by the user. The method for creating and managing a report group further includes generating at least a portion of the reports included in the user-defined report group at a user-defined specific time. The method for creating and managing a report group further includes transmitting the reports to the user via an electronic mail delivery mechanism. The method for creating and managing a report group further includes delaying the generation of at least a portion of the reports included in the user-defined report group until after a process-defined specific time to minimize server loading. The method for creating and managing a report group further includes allowing the user to manage the user-defined report group.

According to a further aspect of this invention, a computer program product resides on a computer readable medium and has a plurality of instructions stored thereon. When executed by the processor, these instructions cause that processor to define a user-defined report group and select, from a plurality of available individual reports, at least a first report to be included in the user-defined report group.

One or more of the following features may also be included. The computer readable medium is a random access memory (RAM), a read only memory (ROM), or a hard disk drive.

According to a further aspect of this invention, a processor and memory are configured to define a user-defined report group and select, from a plurality of available individual reports, at least a first report to be included in the user-defined report group.

One or more of the following features may also be included. The processor and memory are incorporated into a personal computer, a network server, or an array of network servers.

One or more advantages can be provided from the above. Recurring chart specification and definition tasks can be streamlined. Multiple charts can be simultaneously generated. Charts having a common theme or interest can be grouped. Chart groups can be store for later retrieval and use. Groups of charts can be scheduled for automated generation and delivery.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a report group management process;

FIG. 2 is a flow chart depicting a method for creating and managing a report group;

FIG. 3 is a block diagram of another embodiment of the report group management process, including a processor and a computer readable medium, and a flow chart showing a sequence of steps executed by the processor; and

FIG. 4 is a block diagram of another embodiment of the report group management process, including a processor and memory, and a flow chart showing a sequence of steps executed by the processor and memory.

### DETAILED DESCRIPTION

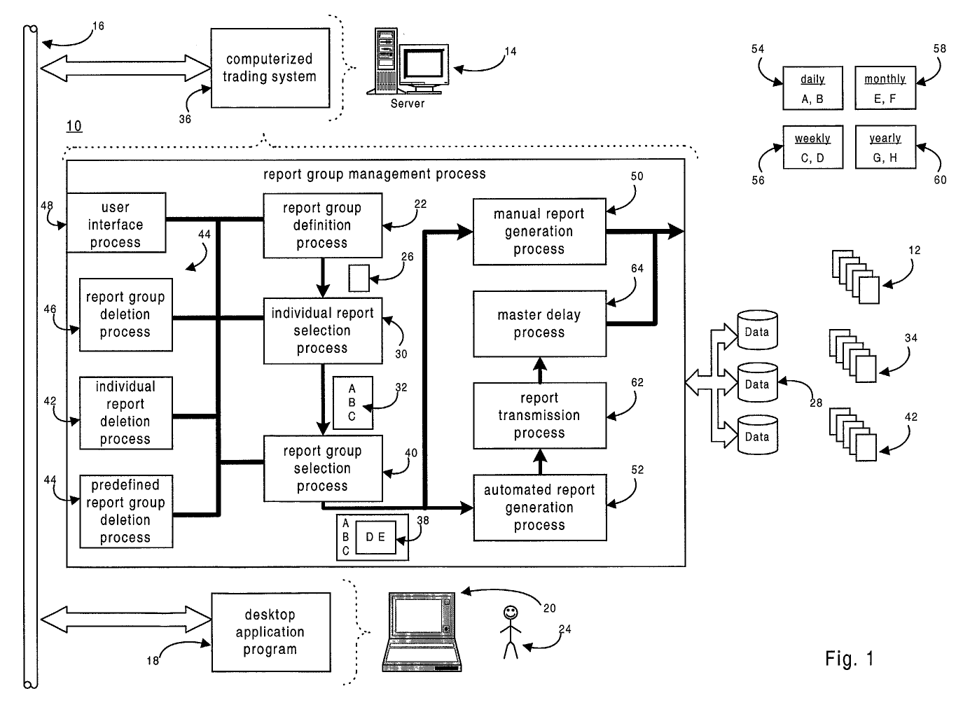

Referring to FIG. 1, there is shown a process 10 for grouping reports 12. Process 10 resides on server 14 and is connected to a distributed computing network 16. Distributed computing network 16 could be the Internet, an intranet, a local area network or any other form of network environment. Process 10 is accessed via a desktop application program 18 running on a remote desktop computer 20, which is also connected to network 16.

Process 10 includes a report group definition process 22 that allows the user 24 to define and save a report group 26. Initially, report group 26 is generally an empty shell, as the report group is empty. The report groups 26 defined by user 24 are stored on data repository 28. Data repository 28 is typically a database, such Oracle™ or Sybase™, and report group management process 10 would typically use an SQL (structured query language) server (not shown) to maintain report groups 26 on data repository 28.

An individual report selection process 30 allows user 24 to select the reports 32 to be included in report group 26. In this illustrative example, report group 26 includes three reports 32 (namely A, B, and C). The number of reports included in report group 26 is controlled by the limit imposed by the administrator of report group management process 10 and/or the number of reports selected by user 24. When selecting these reports 32, user 26 chooses from an assortment of available reports 34 stored on data repository 28.

Typically, report group 26 is referred to as “folio” and an example of process 10 is the Folio Management Service of the Nasdaq Online® system, where user 24 subscribes to process 10. Typically, report group management process 10 is used on a computerized stock trading system 36, such as the Nasdaq™ Stock Market. The reports 36 available on data repository 28 are various reports concerning the status of one or more securities traded on computerized trading system 36. Examples of these reports are last sale summary, trade history, institutional holders summary, etc. Accordingly, when user 24 selects a report 32 to be included in report group 26 from those reports 34 available on data repository 28, user 26 specifies the security to be analyzed and the type of report to be generated for that security.

In addition to individual reports 32 (e.g., A, B, and C), report group 26 can also include entire report groups 38. A report group selection process 40 allows user 24 to select one or more of these predefined report groups 38 to be included in report group 26. User 26 selects these predefined report groups 38 from an assortment of available predefined report groups 42 stored on data repository 28. Specifically, in this particular example, report group 26 is shown to include a plurality of individual reports (i.e., A, B, and C) and one report group 38 which includes a plurality of individual reports (i.e., D and E).

These predefined report groups 42 can be those report groups previously defined by user 26 or they can be report groups defined by the administrator of report group management process 10. An example of these “process-defined” report groups is a report group that generates reports concerning a specific sector of the securities market (e.g., tech sector stocks).

Report group management process 10 includes a suite of tools 44 that allow user 24 to manage the report groups 26 that they have stored on data repository 28. An individual report deletion process 42 allows user 24 to delete one or more of the individual reports 32 included in report group 26. This allows user 24 to remove from report group 26 any report for a security that user 24 no longer wishes to monitor. Further, as report group 26 can also include other predefined report groups 38, report group management process 10 includes a predefined report group deletion process 44 for allowing user 24 to delete one or more of the predefined report groups 38 included in report group 26. This allows user 24 to remove from report group 26 any predefined report group that monitors a securities sector or a group of securities that user 24 is no longer interested in. Additionally, report group management process 10 includes a report group deletion process 46 that allows user 24 to delete an entire report group when the securities (or group of securities) being monitored are on no interest to user 24.

User interface process 48 allows user 24 to manage report group management process 10. This is accomplished by allowing user 24 to access individual report deletion process 42, predefined report group deletion process 44, report group deletion process 46, report group definition process 22, individual report selection process 30, and report group selection process 40. User interface process 48 can be a stand-alone application that resides on desktop computer 20 or it can be an application that resides on server 14 that user 24 accesses through desktop computer 20 via a web browser (not shown).

When user 24 wishes to process report group 26 (and, therefore, generate the individual reports included in this report group), this can be done either manually or automatically.

If manual processing is desired, report group management process 10 includes manual report generation process 50 that allows user 24 to manually initiate the processing of report group 26 and the subsequent generation of the reports included in that report group. Typically, user 24 would perform this manual initiation by executing an on screen prompt (not shown) accessible by user 24 via user interface 48. Typically, the reports generated are posted on an Internet-accessible web site and retrievable/viewable by user 24 via a standard web browser (e.g., Netscape™, Internet Explorer™, etc.). One example of a technique to generate such reports is described in U.S. patent application Ser. No. 09/191,655, entitled “Report Generation Architecture for Remotely Generated Data”, filed on Nov. 13, 1998, and incorporated herein by reference.

As stated above, the processing of report group 26 and the subsequent generation of the individual reports included in the report group can also occur automatically. Therefore, if automatic processing is desired, report group management process 10 includes an automated report generation process 52 that automatically processes the report group 26 at a user-defined interval or on/after a user-defined time. User 24 can set, via user interface 48, these intervals and times. As an example and for illustrative purposes only, if user 24 has report groups 54, 56, 58, and 60 stored on data repository 48, that user can schedule the timing of the processing of these individual report groups via automated report generation process 52. For example, user 26 may schedule: report group 54 to be processed daily; report 56 to be processed weekly; report group 58 to be processed monthly; and report group 60 to be processed yearly. While these report groups are shown to include only two reports each, this is for illustrative purposes only, as the number of reports in each report group can be as large (or as small) as needed.

The scheduling of the processing of these report groups is the subject of U.S. patent application Ser. No. 09/821,599, entitled “A Report Scheduler”, filed on Mar. 29, 2001, and incorporated herein by reference.

Report group management process 10 includes a report transmission process 62 that is responsive to automated report generation process 52 generating the reports included in report group 26. Report transmission process 62 transmits these reports to the user who scheduled them via network 16 and user interface 48. Typically, these reports are sent to their respective users as electronic mail attachments. Naturally, the reports transmitted to the individual users via report transmission process 62 are only those reports scheduled by that specific user.

As the reports generated by process 10 typically report various stock conditions, it is highly desirable to delay the processing of the report groups (and the report generation) until after trading for that day has closed, or generally until late night/early morning when the load on the server 14 that runs process 10 is low and network traffic is reduced. Therefore, master delay process 64 can delay the processing of all report groups (and therefore, the generation of all the individual reports) until after a specific time. Typically, the decision to delay the processing of report groups via master delay process 64 is an administrative decision. Therefore, the person administering process 10, as opposed to the user using process 10, typically decides what time the reports are generated.

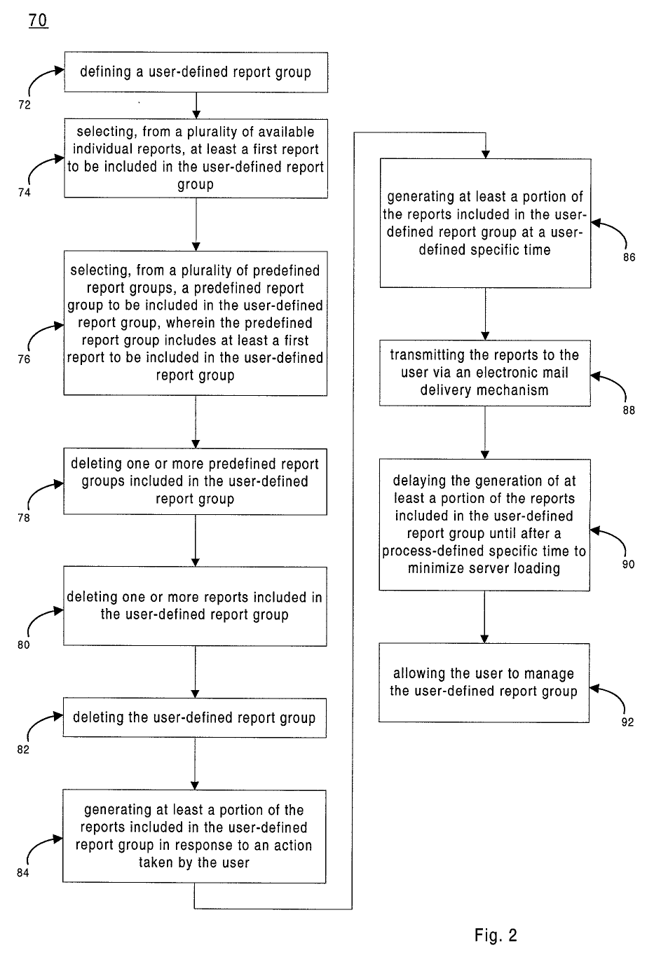

Referring to FIG. 2, a method 70 for creating and managing a report group is shown. Method 70 defines 72 a user-defined report group. Method 70 selects 74, from a plurality of available individual reports, at least a first report to be included in the user-defined report group. Method 70 selects 76, from a plurality of predefined report groups, a predefined report group to be included in the user-defined report group. The predefined report group includes at least a first report to be included in the user-defined report group. Method 70 deletes 78 one or more predefined report groups included in the user-defined report group. Method 70 deletes 80 one or more reports included in the user-defined report group. Method 70 deletes 82 the user-defined report group. Method 70 generates 84 at least a portion of the reports included in the user-defined report group in response to an action taken by the user. Method 70 generates 86 at least a portion of the reports included in the user-defined report group at a user-defined specific time. Method 70 transmits 88 the reports to the user via an electronic mail delivery mechanism. Method 70 delays 90 the generation of at least a portion of the reports included in the user-defined report group until after a process-defined specific time to minimize server loading. Method 70 allows 92 the user to manage the user-defined report group.

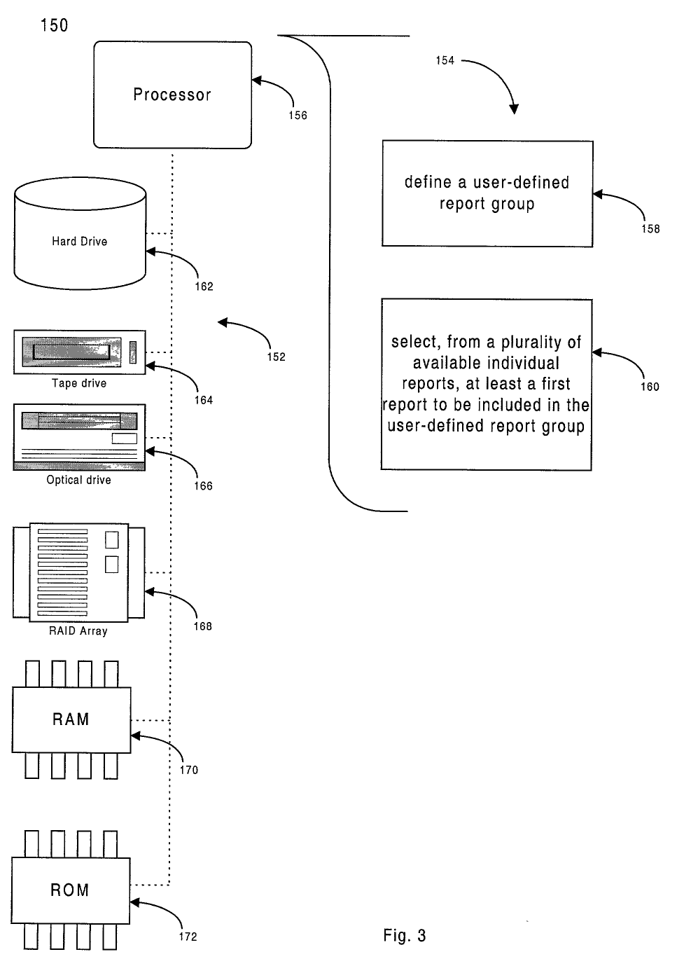

Referring to FIG. 3, there is shown a computer program product 150 residing on a computer readable medium 152 having a plurality of instructions 154 stored thereon. When executed by processor 156, instructions 154 cause processor 156 to define 158 a user-defined report group. Computer program product 150 selects 160, from a plurality of available individual reports, at least a first report to be included in the user-defined report group.

Typical embodiments of computer readable medium 152 are: hard drive 162; tape drive 164; optical drive 166; RAID array 168; random access memory 170; and read only memory 172.

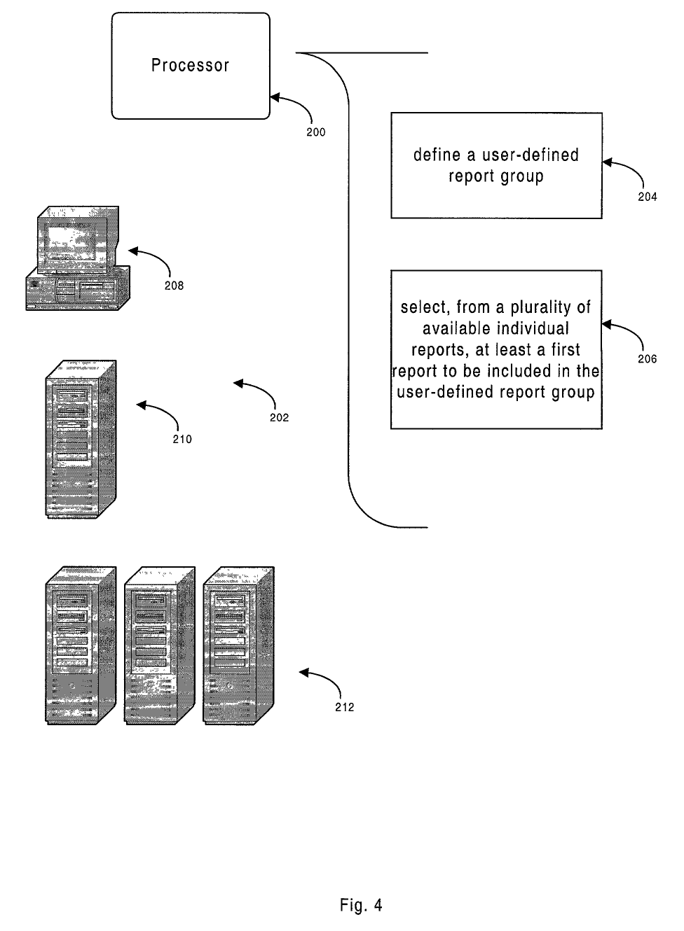

Referring to FIG. 4, there is shown a processor 200 and memory 202 configured to define 204 a user-defined report group. Processor 200 and memory 202 then select 206, from a plurality of available individual reports, at least a first report to be included in the user-defined report group.

Processor 200 and memory 202 may be incorporated into a personal computer 208, a network server 210, or an array of network servers 212.

A number of embodiments of the invention have been described. Nevertheless, it will be understood that various modifications may be made without departing from the spirit and scope of the invention. Accordingly, other embodiments are within the scope of the following claims.

What is claimed is:

1. A report group management process, residing on a server, for grouping a plurality of reports for retrieval over a distributed computing network by an application program residing on a remote desktop computer comprising:
a report group definition process for defining a user-defined report group; and
an individual report selection process for selecting, from a plurality of available individual reports, at least a first report to be included in said user-defined report group.

2. The report group management process of claim 1 further comprising:
a report group selection process for selecting a predefined report group to be included in said user-defined report group from a plurality of predefined report groups, with the predefined report group including at least a first report to be included in said user-defined report group.

3. The report group management process of claim 2 wherein said predefined report group is a user-defined report group.

4. The report group management process of claim 2 wherein said predefined report group is a process-defined report group.

5. The report group management process of claim 2 further comprising:
a predefined report group deletion process for deleting one or more predefined report groups included in said user-defined report group.

6. The report group management process of claim 1 further comprising:
an individual report deletion process for deleting one or more reports included in said use r-defined report group.

7. The report group management process of claim 1 further comprising a report group deletion process for deleting said user-defined report group.

8. The report group management process of claim 1 further comprising: a manual report generation process for generating at least a portion of the reports included in said user-defined report group in response to an action taken by the user.

9. The report group management process of claim 1 further comprising: an automated report generation process for generating at least a portion of the reports included in said user-defined report group at a user-defined specific time.

10. The report group management process of claim 9 further comprising: a report transmission process, responsive to said automated report generation process, for transmitting reports to the user via an electronic mail delivery mechanism.

11. The report group management process of claim 10 further comprising a master delay process that delays the generation of at least a portion of the reports included in said user-defined report group until after a process-defined specific time to minimize server loading.

12. The report group management process of claim 1 further comprising a user interface process for allowing the user to manage said user-defined report group.

13. A report group management process, residing on a server, for grouping a plurality of reports for retrieval over a distributed computing network by an application program residing on a remote desktop computer comprising:
a report group definition process for defining a user-defined report group; and
a report group selection process for selecting a predefined report group to be included in said user-defined report group from a plurality of predefined report groups, with the predefined report group including at least a first report to be included in said user-defined report group.

14. The report group management process of claim 13 wherein said predefined report group is a user-defined report group.

15. The report group management process of claim 13 wherein said predefined report group is a process-defined report group.

16. The report group management process of claim 13 further comprising: an individual report selection process for selecting, from a plurality of available individual reports, at least a first report to be included in said user-defined report group.

17. The report group management process of claim 13 further comprising: a predefined report group deletion process for deleting one or more predefined report groups included in said user-defined report group.

18. The report group management process of claim 13 further comprising: an individual report deletion process for deleting one or more reports included in said user-defined report group.

19. The report group management process of claim 13 further comprising: a report group deletion process for deleting said user-defined report group.

20. The report group management process of claim 13 further comprising: a manual report generation process for generating at least a portion of the reports included in said user-defined report group in response to an action taken by the user.

21. The report group management process of claim 13 further comprising: an automated report generation process for generating at least a portion of the reports included in said user-defined report group at a user-defined specific time.

22. The report group management process of claim 21 further comprising: a report transmission process, responsive to said automated report generation process, for transmitting said reports to the user via an electronic mail delivery mechanism.

23. The report group management process of claim 22 further comprising: a master delay process that delays the generation of said at least a portion of the reports included in said user-defined report group until after a process-defined specific time to minimize server loading.

24. The report group management process of claim 13 further comprising: a user interface process for allowing the user to manage said user-defined report group.

25. A report group management process, residing on a server, for grouping a plurality of reports for retrieval over a distributed computing network by an application program residing on a remote desktop computer comprising:
a report group definition process for defining a user-defined report group;
an individual report selection process for selecting, from a plurality of available individual reports, at least a first report to be included in said user-defined report group; and
a report group selection process for selecting a predefined report group to be included in said user-defined report group from a plurality of predefined report groups, with the predefined report group includes at least a first report to be included in said user-defined report group.

26. The report group management process of claim 25 further comprising an individual report deletion process for deleting one or more reports included in said user-defined report group.

27. The report group management process of claim 25 further comprising a predefined report group deletion process for deleting one or more predefined report groups included in said user-defined report group.

28. The report group management process of claim 25 further comprising a manual report generation process for generating at least a portion of the reports included in said user-defined report group in response to an action taken by the user.

29. The report group management process of claim 25 further comprising an automated report generation process for generating at least a portion of the reports included in said user-defined report group at a user-defined specific time.

30. A method for creating and managing a report group comprising:
defining a user-defined report group; and
selecting, from a plurality of available individual reports, at least a first report to be included in the user-defined report group.

31. The method for creating and managing a report group of claim 30 further comprising selecting, from a plurality of predefined report groups, a predefined report group to be included in the user-defined report group, wherein the predefined report group includes at least a first report to be included in the user-defined report group.

32. The method for creating and managing a report group of claim 30 further comprising deleting one or more predefined report groups included in the user-defined report group.

33. The method for creating and managing a report group of claim 30 further comprising deleting one or more reports included in the user-defined report group.

34. The method for creating and managing a report group of claim 30 further comprising deleting the user-defined report group.

35. The method for creating and managing a report group of claim 30 further comprising generating at least a portion of the reports included in the user-defined report group in response to an action taken by the user.

36. The method for creating and managing a report group of claim 30 further comprising generating at least a portion of the reports included in the user-defined report group at a user-defined specific time.

37. The method for creating and managing a report group of claim 36 further comprising transmitting the reports to the user via an electronic mail delivery mechanism.

38. The method for creating and managing a report group of claim 37 further comprising delaying the generation of at least a portion of the reports included in the user-defined report group until after a process-defined specific time to minimize server loading.

39. The method for creating and managing a report group of claim 30 further comprising allowing the user to manage the user-defined report group.

40. A computer program product residing on a computer readable medium having a plurality of instructions stored thereon which, when executed by the processor, cause that processor to:
define a user-defined report group; and
select, from a plurality of available individual reports, at least a first report to be included in the user-defined report group.

41. The computer program product of claim 40 wherein said computer readable medium is a random access memory (RAM).

42. The computer program product of claim 40 wherein said computer readable medium is a read only memory (ROM).

43. The computer program product of claim 40 wherein said computer readable medium is a hard disk drive.

44. A processor and memory configured to:
define a user-defined report group; and
select, from a plurality of available individual reports, at least a first report to be included in the user-defined report group.

45. The processor and memory of claim 44 wherein said processor and memory are incorporated into a personal computer.

46. The processor and memory of claim 44 wherein said processor and memory are incorporated into a network server.

47. The processor and memory of claim 44 wherein said processor and memory are incorporated into an array of network servers.
